(19) United States
(12) Patent Application Publication
(10) Pub. No.: US 2020/0232087 A1
(43) Pub. Date: Jul. 23, 2020

(54) AESTHETIC COATINGS FOR DENTAL APPLICATIONS

(71) Applicant: N2 Biomedical LLC, Bedford, MA (US)

(72) Inventors: Jason E. BURNS, Cambridge, MA (US); Tim EGGE, Barrington, RI (US)

(21) Appl. No.: 16/749,394

(22) Filed: Jan. 22, 2020

Related U.S. Application Data
(60) Provisional application No. 62/795,925, filed on Jan. 23, 2019.
(60) Provisional application No. 62/863,929, filed on Jun. 20, 2019.

(51) Int. Cl. C23C 14/34; A61C 13/00; C23C 14/16; C23C 14/06; C23C 14/08; C23C 14/10

(52) U.S. Cl. CPC C23C 14/3442; A61C 13/0006; C23C 14/16; C23C 14/10; C23C 14/081; C23C 14/083; C23C 14/0676

(57) ABSTRACT

Techniques for generating a multi-layered thin film coating for dental applications are disclosed. An example of a dental substrate with an aesthetic coating includes a barrier layer deposited on the dental substrate, a textured layer deposited over the barrier layer, the textured layer comprising a first material with features of a size sufficient to scatter light, and at least one protective layer deposited over the textured layer.

### CROSS-REFERENCE TO RELATED APPLICATIONS

This application claims the benefit of U.S. Provisional Application No. 62/795,925, filed Jan. 23, 2019, entitled “AESTHETIC COATINGS FOR DENTAL APPLICATIONS,” and U.S. Provisional Application No. 62/863,929, filed Jun. 20, 2019, entitled “AESTHETIC COATINGS FOR DENTAL APPLICATIONS,” each of which the entire contents are hereby incorporated herein by reference for all purposes.

### BACKGROUND

In some orthodontic treatments, various metallic components may be affixed to the teeth. The two of the most widely used components include brackets, which are bonded directly to the teeth, and archwires, which pass through slots in the brackets while applying force, thereby moving or holding the teeth. Other metallic appliances such as palatal expanders, Herbst appliances, space maintainers, temporary anchorage devices, bands, buccal tubes, and “motion” appliances may also be used in some orthodontic treatments. These devices may be in place for varying lengths of time. For instance, archwires may be in use for just a few weeks, while brackets may be in place for the entire treatment, lasting up to several years.

Many patients avoid appropriate treatment because orthodontic appliances are perceived to be unattractive. This is largely due to the high contrast between the appliance and the natural tooth. The dark, metallic surface of the appliance when viewed against the light natural tooth color causes it to stand out. The majority of orthodontic appliances are fabricated from stainless steel or various alloys of titanium, both of which are relatively dark metals even when polished. This aversion is especially prevalent in adult patients, probably because braces are considered normal for children, but are unusual for adults, and thus stand out more. Because of this negative perception, the orthodontic industry desires aesthetic appliances that closely match the tooth color.

### SUMMARY

An example of a method of generating an aesthetic coating on a substrate according to the disclosure includes providing the substrate to an ion beam assisted deposition system, evaporating a first evaporant proximate to the substrate to realize a first deposition rate, concurrently directing a first ion beam towards the substrate, wherein the first evaporant and the first ion beam are configured to deposit an insulating barrier layer between the substrate and the second layer, evaporating a second evaporant proximate to the first layer to realize a second deposition rate, concurrently directing a second ion beam towards the substrate comprising an ion beam energy and a beam current density, wherein the second deposition rate, the ion beam energy and the beam current density are of values such that a second layer is deposited on the first layer that includes texture elements of a size sufficient to scatter light, subsequently evaporating a third evaporant proximate to the substrate, and directing a third ion beam toward the second layer, wherein the third evaporant and the third ion beam are configured to deposit a protective layer over the second layer.

Implementations of such a method may include one or more of the following features. The second layer may include features having a size sufficient to scatter light, and may be approximately in a range of 100 nanometers to 1000 nanometers. The second evaporant may be aluminum. The substrate may be an orthodontic appliance. The second ion beam may be an argon beam, the ion beam energy is approximately 1000 eV, the beam current density may be approximately 100 μA/cm², and the second deposition rate may be approximately 3 Å/sec. The second ion beam may be an argon beam, the ion beam energy may be approximately 1000 eV, the beam current density may be approximately 200 μA/cm², and the second deposition rate may be approximately 6 Å/sec. The second ion beam may be an argon beam, the ion beam energy may be approximately 1500 eV, the beam current density may be approximately 150 μA/cm², and the second deposition rate may be approximately 4.5 Å/sec. The second ion beam may be an argon beam, the ion beam energy may be in the range of 500 eV to 1500 eV, the ratio of ion beam current density to deposition rate may be in the range of 20 μA/cm²:1 Å/sec to 66 μA/cm²:1 Å/sec. The ratio of ion beam current density to deposition rate may be 33 μA/cm²:1 Å/sec. The ion beam energy may be approximately 1000 eV, the ion beam current density may be approximately 150 μA/cm², and the deposition rate may be approximately 4.5 Å/sec. The first layer may consist of Al₂O₃. The first layer may be selected from a group consisting of SiO₂, ZrO₂, Al₂O₃, and TiO₂, Ta₂O₅, MgO or combinations or mixtures thereof. The second protective layer may consist of SiO₂. The second protective layer may be selected from a group consisting of SiO₂, ZrO₂, Al₂O₃, and TiO₂, Ta₂O₅, MgO or combinations or mixtures thereof. The substrate may comprise stainless steel, titanium, or nickel-titanium. The substrate may be pre-textured with a mechanical or chemical process prior to providing the substrate to the ion beam assisted deposition system.

An example of a dental substrate with an aesthetic coating according to the disclosure includes a barrier layer deposited on the dental substrate, a textured layer deposited over the barrier layer, the textured layer comprising a first material with features of a size sufficient to scatter light, and at least one protective layer deposited over the textured layer.

Implementations of such a dental substrate may include one or more of the following features. The size sufficient to scatter light may be approximately in a range of 100 nanometers to 1000 nanometers. The second layer material may be aluminum. The dental substrate may be an orthodontic appliance. The dental substrate may comprise stainless steel, various alloys of titanium, including beta titanium-molybdenum, nickel-titanium, or copper-nickel-titanium. The barrier layer may comprise Al2O3. The barrier layer may be selected from a group consisting of SiO2, ZrO2, Al2O3, and TiO2, Ta2O5, MgO and their oxynitrides or combinations or mixtures thereof. The protective layer may comprise SiO2. The protective layer may be selected from a group consisting of SiO2, ZrO2, Al2O3, and TiO2, Ta2O5, MgO, and their oxynitrides or combinations or mixtures thereof. The second material may be selected from a group consisting of aluminum, silver, rhodium, and platinum. The textured layer may be deposited with an ion beam assisted deposition process. The textured layer may be deposited with a sputtering process. The textured layer may be deposited with an arc deposition process. The textured layer may be deposited with other physical vapor deposition systems not including a concurrent ion beam.

An example of a dental substrate with an aesthetic coating according to the disclosure includes a barrier layer deposited on the dental substrate, a textured layer deposited over the barrier layer, the textured layer comprising a first material with features of a size sufficient to scatter light, a reflective layer deposited over the textured layer, and at least one protective layer deposited over the reflective layer.

Implementations of such a dental substrate may include one or more of the following features. The textured layer may be titanium. The reflective layer may be a metallic coating. The reflective layer may be a dielectric mirror. The dielectric mirror may include alternating layers of a high refractive index ceramic and a low refractive index ceramic.

An example of a dental substrate with an aesthetic coating according to the disclosure includes a textured layer deposited over the dental substate, the textured layer comprising a first material with features of a size sufficient to scatter light, a reflective layer deposited over the textured layer, and at least one protective layer deposited over the reflective layer.

Items and/or techniques described herein may provide one or more of the following capabilities, as well as other capabilities not mentioned. A substrate may be provided to an ion beam assisted deposition system. The substrate may be an orthodontic appliance. A barrier coating may be deposited on the substrate. A textured coating may be deposited on the barrier coating. The textured coating may include features (texture elements) configured to reflect light. The size of the texture elements may be in the range of 100-1000 nanometers. The size of the features may cause the reflected light to be milky or white in appearance. A protective layer may be deposited over the textured coating. Other capabilities may be provided and not every implementation according to the disclosure must provide any, let alone all, of the capabilities discussed. Further, it may be possible for an effect noted above to be achieved by means other than that noted, and a noted item/technique may not necessarily yield the noted effect.

### BRIEF DESCRIPTION OF THE DRAWINGS

FIG. 1 is an example of an aesthetic coating with a textured surface.

FIG. 2A is an illustration of reflectance spectra in mirror materials.

FIG. 2B is an illustration of specular and diffuse reflection.

FIG. 3 is a schematic an example of a system for ion beam assisted deposition.

FIG. 4 is a graph of computed reflectance of transparent oxides on an aluminum substrate.

FIG. 5 is an example of a textured aluminum layer.

FIG. 6 is an example process flow of a method for generating an aesthetic coating with a protective coating.

FIG. 7 is an example process flow of a method for generating an aesthetic coating.

### DETAILED DESCRIPTION

Techniques are discussed herein for a multi-layered thin film coating for dental applications, for example, a multi-layered thin film coating that may be deposited by ion beam assisted deposition (IBAD). IBAD is a vacuum-based process in which a coating is deposited by electron beam evaporation in the concurrent presence of an ion beam. The layers may be deposited on a substrate and may include a first (innermost) layer of an oxide, nitride, or oxynitride ceramic of approximately 0.1 to 1.0 μm in depth, aluminum of approximately 0.5 to 1.5 μm in depth, and a third (outermost) layer of silica of approximately 1.5 μm in depth. Other depths (e.g., 2, 3, 5 μm and thicker) may be used. The aluminum layer may be textured in such a way as to diffusely reflect visible light. This texture in combination with aluminum's natural brightness results in a milky white appearance. The innermost oxide ceramic layer serves to isolate the substrate from the aluminum layer to prevent deleterious galvanic interactions between the metallic materials, and the silica top layer serves to protect the very soft aluminum from scratching. These techniques are examples only, and not exhaustive.

Current methods of reducing the contrast between the tooth and the appliance are either by generating an aesthetic white/lighter tone on the surface, or by fabricating the device from a clear material. Many of the prior art solutions do not provide durable solutions for various reasons. For example, white epoxy coatings tend to flake off due to poor adhesion, also the coating is typically fairly thick, which may interfere with mechanical tolerances. Teflon coatings tend to be extremely soft, and suffer from poor adhesion, lasting only a few days or weeks in the mouth. Rhodium coatings may be used to form a light metallic color and falls short of matching the natural color of a tooth. Silver coatings may be manufactured to have a white appearance, but silver typically tarnishes easily and ultimately may turn brown in color. Polymer wires may be constructed with a clear appearance but generally do not possess the required mechanical stiffness or strength. Ceramic brackets, such as alumina and zirconia, may be used to fabricate clear brackets, but these can be brittle and prone to cracking.

The aesthetic coatings of the present application achieve whiteness, at least in part, by utilizing by the optical properties of reflectance spectrum, total reflectivity and diffuse reflection (scattering). The reflectance spectrum refers to the range of colors reflected from an object where the color of an object may be defined by the wavelengths of the light reflected from its surface. When illuminated by sunlight, a red object will absorb all colors except red, so the reflected light will contain only the red light that was not absorbed. White materials on the other hand will reflect all colors equally. Total reflectivity differs from reflectance spectrum in that it refers to the total amount of light reflected, A surface with high total reflectivity will appear bright, while a surface with low reflectivity will appear dimmer or black. A specular surface (e.g. a mirror, polished metal, or water) is an example of a surface that reflects all colors equally, but will still not appear white. An image is formed in a mirror because emitted rays are reflected at the same angle as the incident ray; and by extension, parallel rays from an object are reflected by the specular surface in parallel, thus maintaining coherence. In order to break up a coherent reflected image, the reflected light rays must be ejected at angles random to the incident ray. This is called diffuse reflection, or scattering.

The aesthetic coatings, primarily for dental applications, described herein produce a white appearance that has uniform reflectance across the visible spectrum, high total reflectivity, and high scattering.

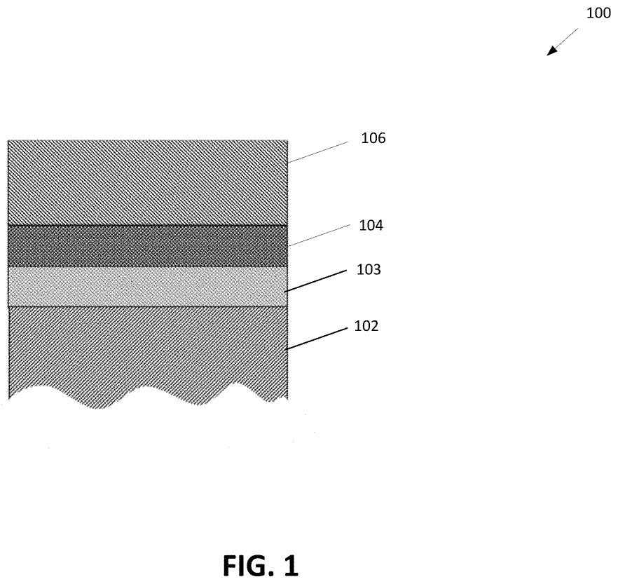

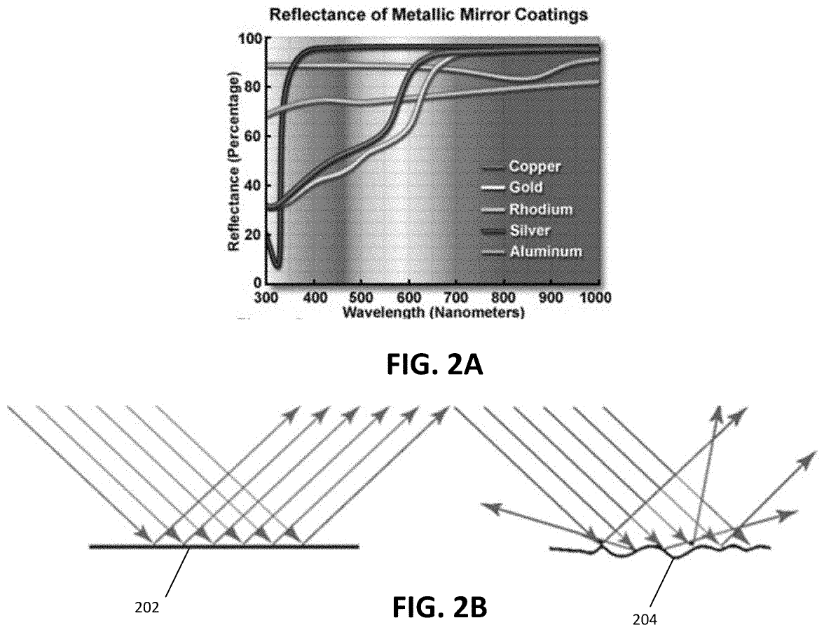

Referring to FIG. 1, an example of an aesthetic coating 100 with textured surface is shown. The coating includes a substrate 102, a oxide ceramic barrier layer 103 (e.g., a first protective layer), a textured layer 104, and a protective layer 106 (e.g., a second protective layer). While FIG. 1 shows three layers, other numbers of layers may be used. In an example, the aesthetic coating 100 may include a textured layer 104 deposited on the substrate 102, and a reflective layer (e.g., aluminum, dielectric mirror) deposited on the textured layer 104. The barrier layer 103 may be an oxide, nitride, oxynitride, or other ceramic barrier layer. In an example, the textured layer 104 may be an textured aluminum layer which fulfills the coating requirements for a wide reflectance spectrum and high total reflectivity by virtue of aluminum's fundamental material properties. For example, referring to FIG. 2A, the reflectance spectra of the most common mirror materials (overlaid on the visible spectrum) is shown. Of these materials, aluminum and silver possess the best combination of reflectance spectrum and total reflectivity. Silver is widely considered the best material for visible light reflection, but may be less preferable in dental applications due to tarnishing. Aluminum is therefore a preferred material. Rhodium and tin may also appear neutral in color because they reflect evenly across the visible spectrum, but will appear dimmer, more grey compared to aluminum due to the lower total reflectivity. Copper and gold material may appear bright due to their high total reflectivity, but will be tinted yellow-red due to absorption of blues and greens.

Referring to FIG. 2B, an illustration of specular reflection 202 and diffuse reflection 204 is shown. The mechanism by which the aluminum layer 104 achieves scatter is through diffuse reflection 204. As described above, in specular reflection 202 from a flat surface, parallel rays are reflected in parallel. In the case of diffuse reflection 204, parallel incoming rays are scattered by a textured surface, which may be thought of as a series of independent mirrors each pointing in a random directions. The scale of the roughness affects the characteristics of the scattered light. In general, light is efficiently scattered by particles or texture elements having a scale similar to the wavelength of the light. In an example, an aesthetic coating may be realized with aluminum features that are approximately 500 nm is size (e.g., approximately wavelength of green light, which is approximately at the center of the visible spectrum). As features become smaller than 100 nm, the aluminum surface typically behaves as if it were flat, and reflects without scattering.

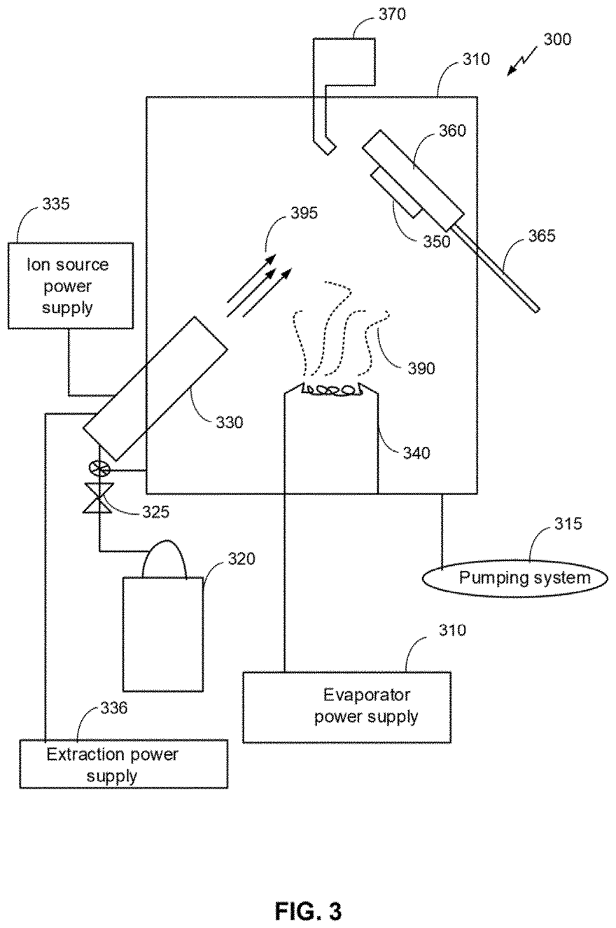

Referring to FIG. 3, a schematic diagram of an example system 300 with a processing chamber for an ion beam assisted deposition (IBAD) process is shown. The system 300 is an example and not limiting and may be altered, e.g., by having components added, removed, or rearranged. A quantity of each component in FIG. 3 is an example only and other quantities of each, or any, component could be used. Such systems are known in the art. For example, U.S. Pat. No. 5,236,509, herein incorporated by reference, describes an IBAD apparatus that is suitable for use in producing a textured aluminum layer 104 in accordance with the disclosure. The system 300 includes a processing chamber 310, a pumping system 315 and a gas supply source 320. The gas supply source 320 is coupled to a mass flow controller 325 and an ion source 330. The mass flow controller may provide gases to the processing chamber 310 at or below a flow rate of 100 standard cubic centimeters per minute (SCCM) flow rate. The gas supply source 320 is configured to supply one or more gases (e.g., Ar, Ne, Xe, He, O, N, etc.) to the ion source 330 and/or the processing chamber 310. The gas supply source 320 may be configured to supply the one or more gases as a backfill gas. The ion source may be a bucket type ion source or other suitable ion source. A mass flow controller 325 regulates the rate of flow of the one or more gases from the gas supply source 320 to the ion source 330. An ion source power supply 335 maintains an arc discharge between the anode and the filaments and an extraction power supply 336 is configured to accelerate the ions through one or more accelerator grids of the ion source 330. The accelerated ions form an ion beam 395. The ion beam energy may be 50-5000 electron volts (eV). The extraction power supply 336 determines the ion beam energy and may determine the arrival rate of the ion beam. The ion source power supply and/or the mass flow controller may determine the arrival rate of the ion beam 395. The ion beam 395 may include one or more gas species.

An evaporator 340 also is mounted in the processing chamber 310 in operative association with the ion source 330. The evaporator 340 may be an electron beam evaporator. The evaporator 340 is designed to vaporize particular metallic evaporants (e.g., vapor plume 390) so as to dry-coat a specific substrate 350 therewith, being assisted in the dry-coating by an ion beam 395 emanating from the ion source 330. Metallic and ceramic evaporants may include Al and its respective alloys, oxides and compounds. The evaporator 340 may include one or more evaporant sources with each evaporant source configured to include one metallic evaporant. Further, the evaporator 340 may be configured to co-evaporate multiple materials and produce the vapor plume 390 including one or more materials. In this case, two or more materials may be co-deposited (i.e., deposited concurrently) onto the substrate 350. An electron beam current of the evaporator 340 determines a deposition rate for the metallic evaporants. The deposition rate of each material may be independently controlled so that each species of multiple materials may have a respective deposition rate. In this way, one or more materials may be added to the vapor plume 390 and varying deposition rates of the various materials may be provided. During co-deposition, the ratio of the multiple materials in the vapor plume 390 may be the same throughout the deposition process or may change. For example, the vapor plume 390 may include more of a particular material than the other materials and the ratio between materials may be selected and controlled as a processing parameter.

The substrate 350 is provided in the processing chamber 310 with the aid of a suitable substrate holder 360. Preferably, the substrate holder 360 is mounted for both rotational and translational motion on a shaft 365. The substrate holder 360 may be a double-planetary fixture. This type of fixture rotates its components around two parallel axes, while simultaneously translating through the treatment zone. This may allow control of and optimization of packing density and coating uniformity for the deposited film. In an embodiment, the substrate holder 360 may be configured as a heat source or heat sink for the substrate. For example, the substrate holder may include a cooling system, such as a water cooling system. The system 300 may include a thickness monitor 370 in operative association with the substrate holder 360 to monitor the thickness of the film being deposited on the substrate 350 during operation of the system 300.

In general, the IBAD process includes a number of parameters, each of which can influence the properties of the film deposited on the substrate surface. A control system including one or more computers and the corresponding software may be operably coupled to the system 300 and configured to control these parameters. Some of these parameters include evaporant deposition rate, electron beam current, arrival rate or current density of the ion beam, ion species, ion beam energy, backfill species, and backfill flow rate. Evaporant deposition rates can vary from about 0.5 Angstroms per second (A/s) to approximately 100 Å/s. The electron beam current is controlled via a feedback loop with the thickness monitor 370 and adjusted based on the desired deposition rate. The current density of the ion beam can be in a range between about 10 to about 500 microamperes per square centimeter per second (μA/cm²/sec). The ion species may be one or more ionized noble gases, for example, Ar, Xe, Ne, He, etc. and/or one or more reactive gases, for example, O, N, etc. The ion beam energy may be 50 electron volts (eV) to about 5000 eV. The backfill species may be one or more reactive gases, for example, oxygen and/or nitrogen. The backfill flow rate may be <100SCCM. Additionally, the crystal size (e.g., an average crystal size or a maximum crystal size) of the deposited film may be a function of the ion beam parameters.

In operation, the system 300 is used in the formation of a textured aluminum layer 104 on a substrate 102. The substrate may be smooth or may be pre-textured via chemical or mechanical means. For example, a conventional grit-blasting approach may be used to initially produce a texture on the surface of the substrate.

In an example, the electron-beam evaporator 340 is used to generate a vapor flux of atoms which condenses on the substrate, while ions (e.g., Ar, N, or O) are simultaneously accelerated into the growing film at energies from several hundred to several thousand eV. This concurrent ion bombardment affects several film properties including morphology, density, film stress, crystallinity, and chemical composition.

All surfaces have some natural topography, and most have inclusions or grain defects resulting in small regions of differing density or crystal structure. Additionally, the initial nucleation patterns of the coating deposition provide a varied topography. These features will have different sputtering properties (sputter yield) than immediately adjacent regions. As a material is sputtered (exposed to an ion beam), either during evaporation or as an independent process, regions of high sputter yield will be preferentially removed, in effect causing lower sputter yield regions to appear to be built up. In addition, faces of features normal to the ion beam are sputtered more, while the other, self-shielded faces, are sputtered less. During the deposition process these imperceptible surface features become exaggerated, and a characteristic texture evolves. Control over these features can be achieved by selecting specific ion beam conditions and manipulating the exposure geometry.

In an example, the textured aluminum layer 104 is generated using a high ion beam energy and current density relative to the evaporation rate. For example, an argon ion beam at 1000 eV energy, and 100 μA/cm² current density with an aluminum deposition rate of 3 Å/sec may be used. When scaling the process, the current density and deposition rate are typically at a fixed ratio, with the energy held constant. Therefore, in order to double the process rate one would use 200 μA/cm2 current density with a deposition rate of 6 Å/sec, while maintaining the 1000 eV energy. To modify the texture, the ion:atom ratio and/or the ion beam energy may be changed. For example, by holding the deposition rate constant at 3 Å/sec, while increasing the ion beam energy and current density to, for example, 150 μA/cm2 and 1500 eV.

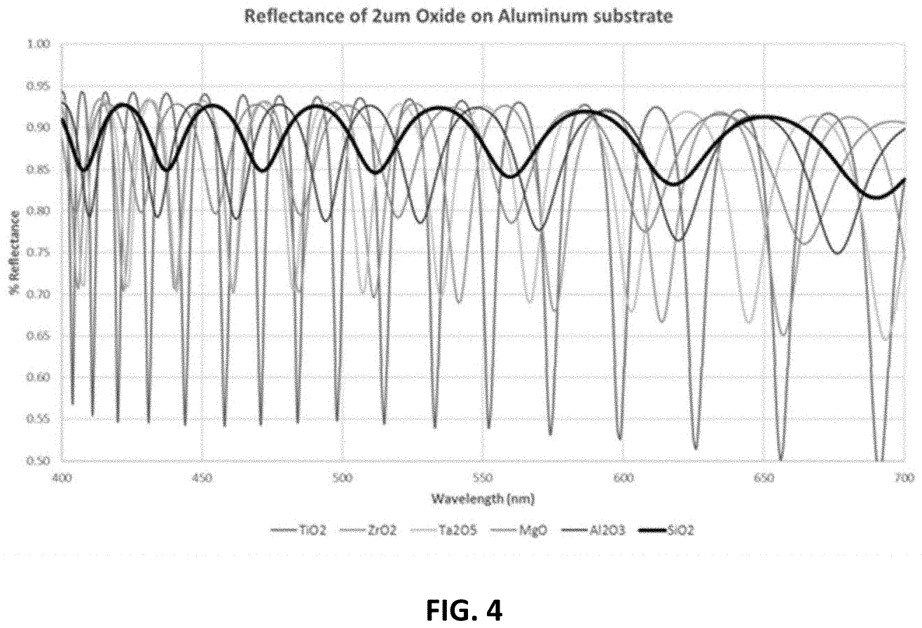

The oxide ceramic barrier and protective layers 103, 106 may be accomplished through common IBAD, sputtering, and other physical vapor deposition techniques (e.g., a physical vapor deposition system not including a concurrent ion beam). The process parameter may be within ranges widely used for optical films. Many different ceramic materials may be used for the barrier and protective layers 103 and 106 such as ZrO2, Al2O3, TiO2, SiO2, and their nitrides or oxynitrides. SiO2 and mixtures thereof may be preferable for the protective layer because SiO2 has a low index of refraction, which gives it favorable transparency/reflectivity properties. For example, referring to FIG. 4, SiO2, when coupled with an aluminum base layer, has the highest total reflectivity of these ceramics, making it the brightest reflector system. Additionally, SiO2 has the lowest dips between peaks, which reduces the tinted reflections that are common to all transparent ceramics. Al2O3 deposited via a variety of techniques may also be used to help improve durability in dental applications.

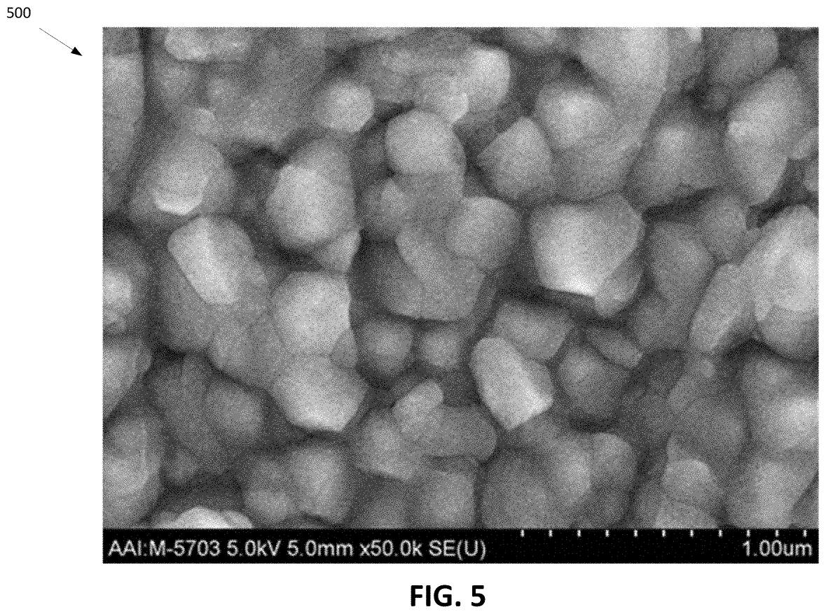

Referring to FIG. 5, an image 500 of example of a textured aluminum layer 104 is shown. The textured aluminum layer 104 includes aluminum features that are approximately in the range of 100 nm and 1000 nm in size (e.g., width and height). Light reflecting from the textured aluminum layer 104 results in an appearance that is milky with fuzzy reflections. As features become smaller than 100 nm, the aluminum surface typically behaves as if it were flat, and reflects without scattering.

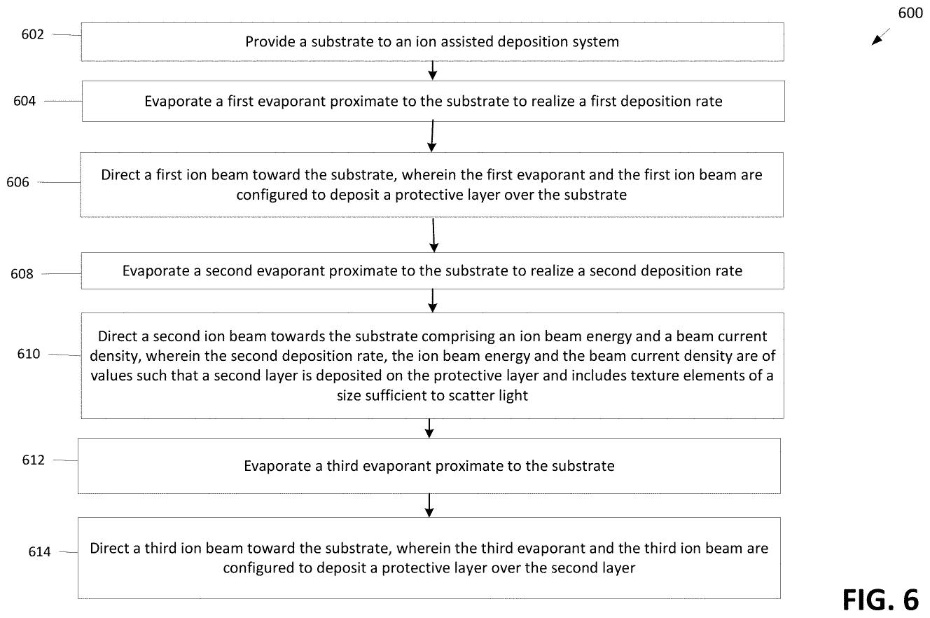

Referring to FIG. 6, with further reference to FIGS. 1-5, a method for generating an aesthetic coating is shown. The method 600 is, however, an example only and not limiting. The method 600 can be altered, e.g., by having stages added, removed, rearranged, combined, performed concurrently and/or having stages split into multiple stages. The method 600 may be modified to include more than three layers.

At stage 602, a method 600 includes providing a substrate to an ion assisted deposition (IBAD) system. For example, the substrate may be an orthodontic appliance comprising stainless steel or other various alloys such as titanium, beta titanium-molybdenum, nickel-titanium, and copper-nickel-titanium, etc. . . . . Other materials may also be used. The IBAD system may be configured to adjust the relative position of the substrate such that an ion beam may be directed at various surfaces of the substrate.

At stage 604, the method 600 includes evaporating a first evaporant proximate to the substrate to realize a deposition rate. For a barrier coating layer 103, the first evaporant may be ZrO2, Al2O3, TiO2, SiO2, their oxynitrides, or the metallic constituent of these compounds combined with an oxygen backfill based on the intended application. The first evaporant may be nitrides or the backfill may include nitrogen gas. In an IBAD system, an evaporation rate may be controlled by varying the temperature of a heating element or power of an electron beam gun.

At stage 606, the method 600 includes directing a first ion beam toward the substrate, wherein the first evaporant and the first ion beam are configured to deposit a barrier layer 103 over the substrate 102. In a multilayer system, the barrier layer 103 may be referred to as a first protective layer, a first protective barrier layer, or an insulating barrier layer. In an example, the protective layer 103 is a SiO2 ceramic layer that is accomplished through common IBAD deposition techniques using moderate levels of ion beam exposure relative to the evaporation. The process parameter may be within ranges widely used for optical films.

At stage 608, the method 600 includes evaporating a second evaporant proximate to the substrate to realize a deposition rate. For a textured aluminum surface, the first evaporant may be aluminum, or other aluminum based materials. Other evaporants such as silver, rhodium, copper, and gold may also be used based on the intended application. In an IBAD system, an evaporation rate may be controlled by varying the temperature of a heating element or power of an electron beam gun. As discussed above, the deposition rate is based on the vapor plume/evaporation rate.

An intermediate layer may also be applied before the barrier layer or before the textured aluminum layer to improve adhesion. This layer may be titanium, zirconium, chromium or another suitable material.

Layers composed of similar elements may be graded into one another. For instance, an aluminum oxide barrier layer could be graded into the aluminum layer by slowing removing the oxygen content as thickness increases.

At stage 610, the method 600 includes directing a second ion beam towards the substrate comprising an ion beam energy and a beam current density, wherein the deposition rate, the ion beam energy and the beam current density are of values such that a second layer is deposited on the protective layer and includes texture elements of a size sufficient to scatter light. In an example, features that are a size sufficient to scatter light may be in a range of approximately 100-1000 nanometers. A textured aluminum coating producing the desired features sizes may be realized using a high ion beam energy and current density relative to the evaporation rate. Specifically, an argon ion beam of 1000 eV energy, and 100 μA/cm² current density with an aluminum deposition rate of 3 Å/sec. Other beam energies, current densities, and evaporation rates may be used to produce the desired features sizes based on the configuration of the IBAD system. In an example, the substrate may be pre-textured via chemical or mechanical means, and the beam energy, current density, and evaporation rate may be varied based on the quality of the pre-textured surface. The ion:atom ratio and/or the ion beam energy may be increased to increase the texture. For example, by holding the deposition rate constant at 3 Å/sec, while increasing the ion beam energy and current density to, for example, 150 μA/cm² and 1500 eV. Further, the method 600 may be scaled such that the current density and deposition rate may be a fixed ratio, with the energy held constant. Thus, the process rate may be doubled by using 200 μA/cm² current density with a deposition rate of 6 Å/sec, while maintaining the 1000 eV energy.

At stage 612, the method 600 includes subsequently evaporating a third evaporant proximate to the substrate. The third evaporant may be used in a second IBAD system, or in a single IBAD system configured to utilize multiple evaporants, or may utilize another coating method, for example thermal evaporation or sputtering. The third evaporant is associated with known clear protective layers such as, but not limited to, ZrO₂, Al₂O₃, TiO₂, and SiO₂ or nitrides, oroxynitrides, or combinations of these. In an example, the third evaporant is silica based to provide a protective layer of SiO₂ over the second layer.

At stage 614, the method 600 includes directing a third ion beam toward the substrate, wherein the third evaporant and the third ion beam are configured to deposit a protective layer 106 over the second layer. In a multilayer device, the protective layer 106 may be referred to as a second protective layer (i.e., wherein the first protective layer may be the barrier layer 103). In an example, the protective layer 106 is a SiO2 ceramic layer that may be accomplished through common IBAD deposition techniques using moderate levels of ion beam exposure relative to the evaporation, or by other methods commonly used to deposit ceramic films. Additional clear protective layers may deposited over the protective layer 106 and the second layer 104. The process parameter are typically within ranges widely used for optical films.

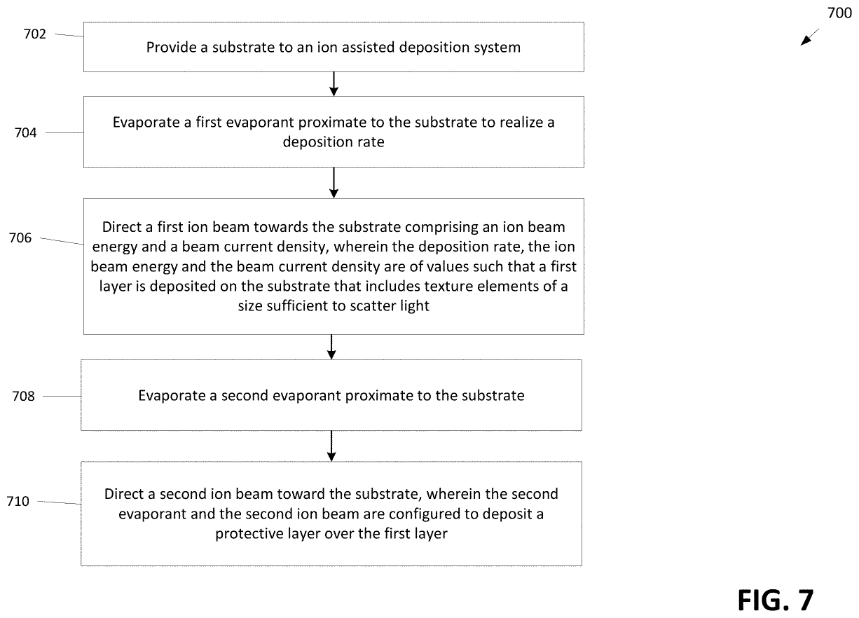

Referring to FIG. 7, with further reference to FIGS. 1-5, a method for generating an aesthetic coating is shown. The method 700 is, however, an example only and not limiting. The method 700 can be altered, e.g., by having stages added, removed, rearranged, combined, performed concurrently and/or having stages split into multiple stages.

At stage 702, a method 700 includes providing a substrate to an ion assisted deposition (IBAD) system. For example, the substrate may be an orthodontic appliance comprising stainless steel or other various alloys such as titanium, nickel-titanium, etc. Other materials may also be used. The IBAD system may be configured to adjust the relative position of the substrate such that an ion beam may be directed at various surfaces of the substrate.

At stage 704, the method 700 includes evaporating a first evaporant proximate to the substrate to realize a deposition rate. For a textured aluminum surface 104, the first evaporant may be aluminum, or other aluminum based materials. Other evaporants such as silver, rhodium, copper, and gold may also be used based on the intended application. In an IBAD system, an evaporation rate may be controlled by varying the temperature of a heating element. As discussed above, the deposition rate is based on the vapor plume/evaporation rate.

An intermediate layer may be applied before the textured aluminum layer to improve adhesion. This layer may be titanium.

At stage 706, the method 700 includes directing a first ion beam towards the substrate comprising an ion beam energy and a beam current density, wherein the deposition rate, the ion beam energy and the beam current density are of values such that a first layer is deposited on the substrate that includes texture elements of a size sufficient to scatter light. In an example, features that are a size sufficient to scatter light may be in a range of approximately 100-1000 nanometers. A textured aluminum coating producing the desired features sizes may be realized using a high ion beam energy and current density relative to the evaporation rate. Specifically, an argon ion beam of 1000 eV energy, and 100 μA/cm² current density with an aluminum deposition rate of 3 Å/sec. Other beam energies, current densities, and evaporation rates may be used to produce the desired features sizes based on the configuration of the IBAD system. In an example, the substrate may be pre-textured via chemical or mechanical means, and the beam energy, current density, and evaporation rate may be varied based on the quality of the pre-textured surface. The ion:atom ratio and/or the ion beam energy may be increased to increase the texture. For example, by holding the deposition rate constant at 3 Å/sec, while increasing the ion beam energy and current density to, for example, 150 μA/cm² and 1500 eV. Further, the method 600 may be scaled such that the current density and deposition rate may be a fixed ratio, with the energy held constant. Thus, the process rate may be doubled by using 200 μA/cm² current density with a deposition rate of 6 Å/sec, while maintaining the 1000 eV energy.

At stage 708, the method 700 includes subsequently evaporating a second evaporant proximate to the substrate. The second evaporant may be used in a second IBAD system, or in a single IBAD system configured to utilize multiple evaporants. The second evaporant is associated with known clear protective layers such as, but not limited to, ZrO₂, Al₂O₃, TiO₂, and SiO₂ or combinations of these. In an example, the second evaporant is silica based to provide a protective layer of SiO₂ over the first layer.

At stage 710, the method 700 includes directing a second ion beam toward the substrate, wherein the second evaporant and the second ion beam are configured to deposit a protective layer 106 over the first layer. In an example, the protective layer 106 is a SiO₂ ceramic layer that is accomplished through common IBAD deposition techniques using moderate levels of ion beam exposure relative to the evaporation. The process parameter are typically within ranges widely used for optical films.

Other metals may be substituted for the aluminum in the reflective layer 104. For example, reflective metals may include silver, aluminum, platinum, rhodium and tin. The primary trade-off is reduced brightness. Platinum, for example, reflects evenly across the spectrum, and is considered to be a bright, light metal, but it in fact reflects only 60-70% of light, as compared to silver (95%), aluminum (90%), and rhodium (75-80%).

Other deposition techniques may be used to generate the required texture in a more cost effective way (sputtering, arc deposition, physical vapor deposition, etc.). Alternatively, a process could be used to quickly build the reflective layer (plating), which would then be textured by a number of means, e.g. laser texturing, or acid etching.

Other IBAD based processes may also be used to generate the textured layer. For example, the textured layer may be produced using other suitable metals, such as titanium, for its adhesion properties and then coating that metal with a thin metallic reflective layer, or a dielectric mirror may be utilized. A dielectric mirror may be deposited on top of the textured layer by deposition of alternating layers of high and low refractive index ceramics. In a simple representation of a dielectric mirror, the thickness of each layer may be an integral multiple of the wavelength of light to be reflected. One common example of material pair would be TiO2 for the high index material and SiO2 for the low index material. Other more complex methods of creating a dielectric mirror may also apply.

Other ceramics may be employed for the protective layer 106. Important parameters to consider are the optical properties and hardness. In general, SiO2 has very good optical properties owing to its low index of refraction and it possesses excellent reflectivity with reduced color fringing. SiO2 is relatively soft for an optical oxide, which may reduce its ability to protect a very soft aluminum reflective layer. Another option is ZrO2, which is considerably harder than SiO2, but yields strong color fringes, which may distract from a white coating. Al2O3 may also be used based on good clarity and high hardness Other oxides having varying index of refraction and hardness properties may be used, each having its own cost-benefit trade-off.

Colored metals like copper, gold, or oxides like iron oxide may be used to achieve an off-white tint, to better blend in with the natural tooth color. These colorants may be applied by mixing with the aluminum during the deposition process (e.g., a co-deposition, comprising two independent deposition processes are run concurrently such that both evaporant materials are incident on the substrate). A co-deposition process typically yields a uniform and highly controllable mixture of the two materials. Colorants may also be applied by first growing a normal aluminum textured layer, and then a thin (typically <100 Å) layer of toning material may be applied on top of the aluminum textured layer.

Optical tinting may be used to tone the surface. Stacks of thin layers of varying clear ceramics may be designed which yield unique reflectance spectra. It is possible to use this technique to introduce a specifically desired tint.

Combinations or mixtures of ceramics may also be considered to maximize clarity and durability. For example a thick SiO2 layer could be used as the majority of the protective layer, but it could be capped by a thin ZrO2 layer for additional hardness. There are other potential combinations.

In an embodiment, the textured-aluminum reflective layer may be susceptible to corrosion. Measures may be taken to reduce its exposure to the acidic or electrolytic solutions that are common in the oral environment. In an example, the protective outer ceramic layer's primary purpose may be to protect the metallic layer from mechanical damage, but a secondary purpose may be to protect the metallic layer from corrosion (diffusion barrier layer). In order for the ceramic protective layer to act as an effective diffusion barrier, it may be fully densified and amorphous to reduce diffusion through the ceramic matrix, which may occur primarily between grain boundaries. Also, the nano and micro pinholes that are a normal product of evaporation processing may be minimized to reduce the straight path through the coating. An additional thin, highly conformal top layer of ceramic may be applied by other techniques to seal pores in the outer protective layer, thus reducing the potential for corrosion. These techniques include atomic layer deposition, and the entire family of chemical vapor deposition processes. In addition to “sealing” the protective ceramic layer, chemical vapor deposition may also be used instead of IBAD to deposit the entire protective layer.

A fully densified, amorphous film may be realized through the IBAD process by increasing the ion-beam:evaporant ratio. Ion beam exposure increases surface atom mobility, which densities the film while at the same time breaking up crystalline structure before formation. The use of oxynitrides (SiOₓN_{y}, AlOₓN_{y}, etc. . . . ) is also known to reduce diffusion through the ceramic matrix. Its activity has been attributed to chemical trapping of H2O, and reduction in the size of the fundamental matrix element.

Micro pin-holes may be caused by particulates landing on the substrate, which shadow the area under it, and then fall off leaving a gap in the coating. Reduction of micro pinholes in the ceramic film is addressed primarily through careful “housekeeping” of the deposition chamber; the chamber walls and ceiling may be kept clean to reduce flaking. Additionally proper evaporation technique must be adhered to in an effort to reduce particulate ejection from the evaporation crucible. Nano and micro pin-holes may be caused by nucleation patterns, and defects in the growing ceramic matrix. In general, these pinholes are common to all physical vapor deposition techniques and may be minimized, but typically cannot be eliminated entirely. A pinhole that connects the surface directly to the metallic reflective layer may allow solutions to quickly pass through. The techniques described above (e.g., film densification, amorphizing, and nitrogen) can reduce the size of some pin-holes. In an example, another effective technique includes introducing multiple layers having different growth mechanisms. This may create disconnects between the layers wherein the pin-holes within each layer do not line up with each other, forcing the solution to diffuse horizontally along the layer boundary to the next pin-hole. This resulting “torturous path” may significantly retard the diffusion of solution through a ceramic film. Options to introduce layers of variable growth mechanism include: very high/very low ion-beam:evaporant ratio; very high/very low ion beam energy; nitride phase/no nitride phase; and layers of pure ion beam sputtering with no concurrent deposition, layers of different materials, which may include: SiO2, ZrO2, Al2O3, and TiO2, Ta2O5, MgO, or their oxinitrides.

In an example, Al2O3 exhibits a unique phase change when exposed to steam or boiling water wherein “boehmite” or “hydrated alumina” is formed. This phase of alumina has a lower density than typical amorphous IBAD alumina, and therefore increases in volume when formed. This property may be used to fill voids or pinholes. An alumina layer may be incorporated at or near the surface so that a post deposition steam or boiling water treatment may activate the hydrated phase, thus filling the voids. Hydrated alumina is softer than typical alumina, so it does not have adequate mechanical properties to protect the reflective metallic layer, this may require its use in combination with other techniques.

These techniques may be combined as well, for instance a high ion beam:evaporant ratio SiO2 film could be alternated with a low ion-beam:evaporant ratio Al2O3 film.

A number of alternating layers may be utilized. The thicknesses of each layer can vary. For example, a thick SiO2 layer deposited with a moderate ion-beam energy may be alternated with extremely thin layers having a high energy ion-beam. A number of these techniques may be combined in a number of layers for example: a four layers system could be produced having: a moderate ion-beam:evaporant ratio SiO2 layer; a thin layer of ion beam sputtering; an aluminum oxynitride layer; and a high ion-beam:evaporant ratio SiO2 layer.

An additional thin, highly conformal top layer of ceramic may be applied by other techniques to seal pores in the outer protective layer, thus reducing the potential for corrosion. These techniques include atomic layer deposition, and the entire family of chemical vapor deposition processes.

The above techniques may be applied to the inner ceramic barrier layer as well as the top ceramic protective layer. The metallic reflective layer also may form pinholes, which may allow communication of acid or electrolytic solutions between the outer surface and the substrate. The techniques described above may also be applied to this layer. For example, the textured metallic layer may be grown with several thin oxide layers interspersed throughout its thickness.

The methods, systems, and devices discussed above are examples. Various configurations may omit, substitute, or add various procedures or components as appropriate. For instance, in alternative configurations, the methods may be performed in an order different from that described, and that various steps may be added, omitted, or combined. Also, features described with respect to certain configurations may be combined in various other configurations. Different aspects and elements of the configurations may be combined in a similar manner. Also, technology evolves and, thus, many of the elements are examples and do not limit the scope of the disclosure or claims.

Specific details are given in the description to provide a thorough understanding of example configurations (including implementations). However, configurations may be practiced without these specific details. For example, well-known circuits, processes, algorithms, structures, and techniques have been shown without unnecessary detail in order to avoid obscuring the configurations. This description provides example configurations only, and does not limit the scope, applicability, or configurations of the claims. Rather, the preceding description of the configurations provides a description for implementing described techniques. Various changes may be made in the function and arrangement of elements without departing from the spirit or scope of the disclosure.

Also, configurations may be described as a process which is depicted as a flow diagram or block diagram. Although each may describe the operations as a sequential process, some operations may be performed in parallel or concurrently. In addition, the order of the operations may be rearranged. A process may have additional stages or functions not included in the figure.

Having described several example configurations, various modifications, alternative constructions, and equivalents may be used without departing from the spirit of the disclosure. For example, the above elements may be components of a larger system, wherein other rules may take precedence over or otherwise modify the application of the invention. Also, a number of operations may be undertaken before, during, or after the above elements are considered. Accordingly, the above description does not bound the scope of the claims.

“About” and/or “approximately” as used herein when referring to a measurable value such as an amount, a temporal duration, and the like, encompasses variations of ±20% or ±10%, ±5%, or +0.1% from the specified value, as appropriate in the context of the systems, devices, circuits, methods, and other implementations described herein. “Substantially” as used herein when referring to a measurable value such as an amount, a temporal duration, a physical attribute (such as frequency), and the like, also encompasses variations of ±20% or ±10%, ±5%, or +0.1% from the specified value, as appropriate in the context of the systems, devices, circuits, methods, and other implementations described herein.

Further, more than one invention may be disclosed.

1. A method of generating an aesthetic coating on a substrate, comprising:
providing the substrate to an ion beam assisted deposition system;
evaporating a first evaporant proximate to the substrate to realize a first deposition rate;
concurrently directing a first ion beam towards the substrate, wherein the first evaporant and the first ion beam are configured to deposit a first protective barrier layer over the substrate;
evaporating a second evaporant proximate to the substrate to realize a second deposition rate;
concurrently directing a second ion beam towards the substrate comprising an ion beam energy and a beam current density, wherein the second deposition rate, the ion beam energy and the beam current density are of values such that a second layer is deposited on the first protective barrier layer and includes texture elements of a size sufficient to scatter light;
subsequently evaporating a third evaporant proximate to the substrate; and
directing a third ion beam toward the substrate, wherein the third evaporant and the third ion beam are configured to deposit a second protective layer over the second layer.

2. The method of claim 1 wherein the size sufficient to scatter light is approximately in a range of 100 nanometers to 1000 nanometers.

3. The method of claim 1 wherein the second evaporant is aluminum.

4. The method of claim 1 wherein the second evaporant is selected from a group consisting of silver, platinum, rhodium and tin.

5. The method of claim 1 wherein the substrate is an orthodontic appliance.

6. The method of claim 1 wherein the second ion beam is an argon beam, the ion beam energy is approximately 1000 eV, the beam current density is approximately 150 μA/cm², and the second deposition rate is approximately 3 Å/sec.

7. The method of claim 1 wherein the second ion beam is an argon beam, the ion beam energy is approximately 1000 eV, the beam current density is approximately 300 μA/cm², and the second deposition rate is approximately 6 Å/sec.

8. The method of claim 1 wherein the second ion beam is an argon beam, the ion beam energy is approximately 1500 eV, the beam current density is approximately 150 μA/cm², and the second deposition rate is approximately 3 Å/sec.

9. The method of claim 1 wherein the second ion beam is an argon beam, the ion beam energy is in a range of 500 eV to 1500 eV, a ratio of ion beam current density to deposition rate is in a range of 20 μA/cm²:1 Å/sec to 66 μA/cm²:1 Å/sec.

10. The method of claim 8 wherein the ratio of ion beam current density to the deposition rate is 33 μA/cm2:1 Å/sec.

11. The method of claim 8 wherein the ion beam energy is approximately 1000 eV, an ion beam current density is approximately 150 μA/cm², and the deposition rate is approximately 3 Å/sec.

12. The method of claim 1 wherein the second protective layer consists of Al₂O₃.

13. The method of claim 1 wherein the second protective layer is selected from a group consisting of SiO₂, ZrO₂, Al₂O₃, and TiO₂, Ta₂O₅, MgO, their nitrides and oxynitrides or combinations or mixtures thereof.

14. The method of claim 1 wherein the second protective layer consists of SiO₂.

15. The method of claim 1 wherein the substrate comprises stainless steel, titanium, and various alloys of titanium, including beta titanium-molybdenum, nickel-titanium, and copper-nickel-titanium.

16. The method of claim 1 further comprising pre-texturing the substrate with a mechanical or chemical process prior to providing the substrate to the ion beam assisted deposition system.

17. A dental substrate with an aesthetic coating, comprising:
a barrier layer deposited on the dental substrate;
a textured layer deposited over the barrier layer, the textured layer comprising a first material with features of a size sufficient to scatter light; and
at least one protective layer deposited over the textured layer.

18. The dental substrate of claim 17 wherein the size sufficient to scatter light is approximately in a range of 100 nanometers to 1000 nanometers.

19. The dental substrate of claim 17 wherein a textured layer material is aluminum.

20. The dental substrate of claim 17 wherein the dental substrate is an orthodontic appliance.

21. The dental substrate of claim 17 wherein the dental substrate comprises stainless steel, titanium, and various alloys of titanium, including beta titanium-molybdenum, nickel-titanium, and copper-nickel-titanium.

22. The dental substrate of claim 17 wherein the barrier layer comprises Al₂O₃.

23. The dental substrate of claim 17 wherein the barrier layer is selected from a group consisting of SiO2, ZrO2, Al2O3, and TiO2, Ta2O5, MgO, their nitrides and oxynitrides or combinations or mixtures thereof.

24. The dental substrate of claim 17 wherein the at least one protective layer comprises SiO₂.

25. The dental substrate of claim 17 wherein the at least one protective layer is selected from a group consisting of SiO2, ZrO2, Al2O3, and TiO2, Ta2O5, MgO, their oxynitrides or combinations or mixtures thereof.

26. The dental substrate of claim 17 wherein a textured layer material is selected from a group consisting of titanium, silver, rhodium, platinum, and tin.

27. The dental substrate of claim 17 wherein the textured layer is deposited with an ion beam assisted deposition process.

28. The dental substrate of claim 17 wherein the textured layer is deposited with a sputtering process.

29. The dental substrate of claim 17 wherein the textured layer is deposited with an arc deposition process.

30. The dental substrate of claim 17 wherein the textured layer is deposited with a physical vapor deposition system not including a concurrent ion beam.

31. A dental substrate with an aesthetic coating, comprising:
a textured layer deposited over the dental substrate, the textured layer comprising a first material with features of a size sufficient to scatter light;
a reflective layer deposited over the textured layer; and
at least one protective layer deposited over the reflective layer.

32. The dental substrate of claim 31 wherein the textured layer is titanium.

33. The dental substrate of claim 31 further comprising a barrier layer deposited on the dental substrate, wherein the textured layer is deposited over the barrier layer.

34. The dental substrate of claim 33 wherein the reflective layer is a metallic coating.

35. The dental substrate of claim 31 wherein the reflective layer is a dielectric mirror.

36. The dental substrate of claim 34 wherein the dielectric mirror comprises alternating layers of a high refractive index ceramic and a low refractive index ceramic.
